(19) United States
(12) Patent Application Publication
(10) Pub. No.: US 2022/0292487 A1
(43) Pub. Date: Sep. 15, 2022

(54) METHODS AND SYSTEMS FOR IMAGE SENSOR-BASED SIGNAGE INTIATED TRANSACTIONS

(71) Applicant: Cosmin-Gabriel ENE, Zollikon (CH)

(72) Inventor: Cosmin-Gabriel ENE, Zollikon (CH)

(21) Appl. No.: 17/635,316

(22) PCT Filed: Aug. 17, 2020
(86) PCT No.: PCT/EP2020/072982

§ 371 Date: Feb. 14, 2022

Related U.S. Application Data
(60) Provisional application No. 62/887,169, filed on Aug. 15, 2019.

(51) Int. Cl. G06Q 20/32

(52) U.S. Cl. CPC G06Q 20/3276

(57) ABSTRACT

Initiating a rapid convenient purchase transaction for services based on the capture of image of coded signage for such transaction includes the steps taken by a computing device of a) capturing by an image sensor an image of service code signage depicting a code associated with an offered fee-based service, b) processing the captured image of the service code signage to identify an address of a first network-accessible computer server associated with the offered fee-based service and at least one parameter associated with the offered fee-based service, c) transmitting to the first computer server address information of the at least one parameter associated with the offered fee-based service, and a network-accessible address associated with the mobile device, d) receiving from the first computer server, information associated with the offered fee-based service including at least a fee for the fee-based service, e) displaying on the mobile device, the received information and at least two payment options including an immediate payment option and a deferred payment option, f) receiving from a user of the mobile device, a selected payment option, g) transmitting to the first computer server address, information indicative of the selected payment option, h) transmitting a unique identifier to an address of network-accessible second computer server when said deferred payment option is selected, wherein the second computer server is associated with a deferred payment service provider, and i) receiving information of a completed transaction for the offered fee-based service including at least a unique transaction identifier and a parameter associated with at least one aspect of the fee-based service to be used.

### FIELD OF THE INVENTION

This disclosure pertains to methods and systems for initiating a convenient purchase transaction for services based on the capture of image of coded signage by user's computing device.

### BACKGROUND

Consumers are often rushed or otherwise in a hurry leaving little time for engaging in the process of purchasing access tickets to certain time-sensitive services including, for example, trains, buses or theater shows. Traditionally, such consumers must purchase ticket or other access rights to such services using a ticket booth or agent, or automated ticket vending machine, and often must stand in queue for such purchases wasting valuable time, or worse being late to a theater show, or missing the departure of a bus or train.

More recently, service providers have offered applications or “apps” for mobile computing devices for speeding up the above traditional process by enabling consumers to purchase tickets or access to such time-sensitive services via internet-accessible servers. In such instances, the servers transmit an electronic ticket for display on the mobile device instead of a paper ticket to provide proof of purchase of such services. Although this provides a convenient and more rapid way to purchase tickets, it still requires multiple steps that although less time consuming than ticket purchases from an agent, still require an undesirable level of effort and time consumpiton. Such conventional apps often require the consumer to execute an undesirable number of steps including, for example, activating the app, log-in to account, selecting the desired service, and entering payment account information and confirming payment for receipt of an electronic ticket for such service.

A more rapid way of purchasing tickets or other rights to time-sensitive services is desired by many consumers.

### SUMMARY

By way of example, aspects of the present disclosure are directed to methods and systems for initiating a rapid convenient purchase transaction for services based on the capture of image of coded signage for such transaction.

In accordance with aspects of the present disclosure, the disclosed mobile device computer-implemented method includes the steps of: a) capturing by an image sensor of a mobile device, an image of service code signage depicting a code associated with an offered fee-based service, b) processing the captured image of the service code signage to identify an address of a first network-accessible computer server associated with the offered fee-based service and at least one parameter associated with the offered fee-based service, c) transmitting to the address of the first computer server, information of the at least one parameter associated with the offered fee-based service, and a network-accessible address associated with the mobile device, d) receiving from the first computer server, information associated with the offered fee-based service including at least a fee for use of the fee-based service, e) displaying on the mobile device, the received information and at least two payment options including an immediate payment option and a deferred payment option, f) receiving from a user of the mobile device, a selected payment option for use of the fee-based service, g) transmitting to the address of the first computer server, information indicative of the selected payment option for the offered fee-based service, h) transmitting a unique identifier to an address of network-accessible second computer server when said deferred payment option is selected, wherein the second computer server is associated with a deferred payment service provider, and i) receiving information of a completed transaction for the offered fee-based service including at least a unique transaction identifier and a parameter associated with at least one aspect of the fee-based service to be used.

In accordance with an additional aspect of the disclosure, the displaying step is performed when the fee is below a pre-determined threshold amount; and further comprises the step of displaying on the mobile device, the received information and at least one payment for immediate payment when the fee is above the pre-determined threshold amount.

In accordance with further aspects of the disclosure, the disclosed mobile device computer-implemented method further includes the step of displaying on the mobile device, the at least one immediate payment option, wherein the at least one immediate payment immediate payment option includes immediate payment by a third party payment service provider.

This SUMMARY is provided to briefly identify some aspects of the present disclosure that are further described below in the DESCRIPTION. This SUMMARY is not intended to identify key or essential features of the present disclosure nor is it intended to limit the scope of any claims.

### BRIEF DESCRIPTION OF THE DRAWING

A more complete understanding of the present disclosure may be realized by reference to the accompanying drawing in which:

FIG. 1 depicts an exemplary ticket vending machine having service code signage disposed thereon useable in accordance with aspects of the present disclosure;

FIG. 2 depicts an exemplary message sequence diagram in accordance with aspects of the present disclosure;

FIG. 3 depicts an exemplary mobile device display depicting representative multiple payment options for an offered service in accordance with aspects of the present disclosure; and

FIG. 4 depicts an exemplary mobile device display depicting a representative single payment option for an offered service in accordance with aspects of the present disclosure.

### DETAILED DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements later developed that perform the same function, regardless of structure.

Unless otherwise explicitly specified herein, the drawings are not drawn to scale.

Aspects of the present disclosure are directed to methods and systems for initiating a convenient purchase transaction for services based on the capture of image of coded signage for such transaction by, for example, a mobile device (also termed a “User Equipment Device,” or “UE device”). Such devices may include, but are not limited to, personal digital assistants (PDAs), smartphones, tablet devices, and other devices capable of executing software application programs that may have been pre-installed in a non-activated state on the device, or are dynamically installed, for example, in a non-activated state via a network connection to a system that offers applications and features for download and licensing, e.g., App Store, (“AS”). These software applications are programs stored in the UE device to be activated and then executed by a processor of the device when execution is triggered, that is when the application is started.

In accordance with the present disclosure, the UE device is configured with an operating system and other software applications. A local memory of the UE device stores license information for one or more of the installed apps that the UE device is currently licensed to use.

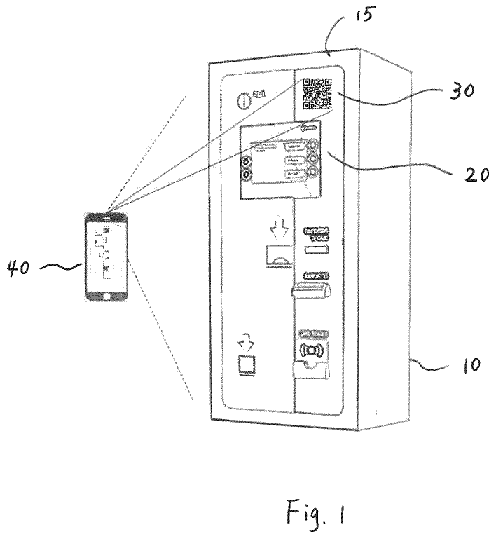

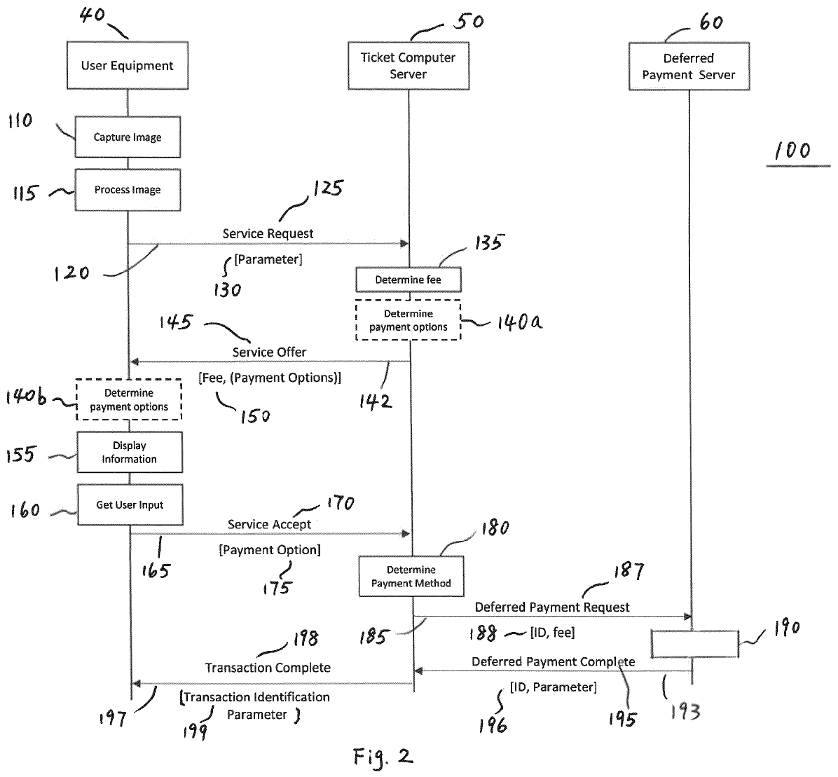

With reference to the drawing figures, FIG. 1 depicts an exemplary ticket vending machine 10 for the purchase of, for example, train tickets. The ticket vending machine 10 has a human machine interface elements 20 that allows for purchase of train tickets directly from the machine 10. In addition, the machine 10 has a code signage 30 in the form of, for example, a quick response or “QR” code, disposed on a surface 15 of the machine 10 so that it is well visible to potential ticket purchasers. The code signage 30 is a graphical code represents information including an internet-accessible of an address of ticket computer server 50 (shown in FIG. 2) for purchasing tickets. In addition, the graphical code of code signage 30 in this example, also represents information of an identification of a rail station where the machine 10 is located, i.e., the departure station. The code signage 30 may alternatively be, for example, a two-dimensional or three-dimensional bar code, or any other type of graphical encoding of relevant information in a visual signage.

The code signage 30 is a service code signage that facilitates the purchasing of tickets from the ticket computer server. A representative mobile device or user equipment 40 (UE) is able to capture an image of the code signage 30, to identify the internet-accessible address of the ticket computer server online and additional parameters for purchasing, e.g. the departure station and optionally, destination station, and use both according to the inventive method described herein to advantageously rapidly use the service code signage 30 for an advantageously reduced number of steps than known methods, to purchase a ticket and enter a payment transaction in accordance with this disclosure.

Although the code signage 30 is depicted on the ticket vending machine 10, it should be readily understood that such code signage 30 may be located anywhere that would enable a user to capture image of such signage. Moreover, multiple code signage may be displayed proximate one another representing different offered services, e.g., for different destination locations for rail service, or different show starting times for theaters.

FIG. 2 illustrates a diagram of an exemplary process sequence 100 in accordance with this disclosure. FIG. 2 depicts the process sequence 100 as a communication exchange between the UE 40, first computer server 50, e.g., a ticket computer server, and a second computer server 60, e.g., a deferred payment server, by means of arrows representing communication messages with the communication message names or titles appearing above the respective arrow, and corresponding data or information elements communicated with the message identified appearing in brackets [ ] below the respective arrows.

The process sequence 100 begins at step 110 with the UE 40 capturing an image of the code signage 30 with an image sensor, for example, a camera sensor integrated within, or otherwise in communication with, the UE 40. The image captured is an image of the code signage 30 (shown in FIG. 1). The code signage 30 is indicative of an internet-accessible address of the ticket computer server 50 and additional data in connection for purchasing, e.g. the departure station and optionally, destination station.

The captured image of the code signage 30 is then processed by the UE 40 in step 115 to identify information of at least the Internet-accessible address of the ticket computer server 50. The identified information may further comprise parameter data directed to descriptive information about the fee-based service, i.e. a specific one of a plurality of different services offered, location information and/or starting/departure time related to the fee-based service. In one example, the further parameter data may comprise location information in the fowl of an identification of departure and destination rail stations indicated with the particular service code signage 30 captured by the UE 40.

In step 120, the UE 40 transmits a Service Request 125 to the ticket computer server 50 at the internet-accessible address, information encoded in relation to the code signage 30. The Service Request 125 may identify the service requested, e.g. purchasing a ticket, and it may comprise data for one or more of the further parameters 130, e.g. the departure and destination rail stations information described above. More information may be included in the parameters 130 sent to the ticket computer server 50, e.g., the date, time of day, identification data of the UE 40 and/or further parameter data specifying the specific service requested from the ticket computer server 50.

In step 135, the ticket computer server 50 may determine a fee for the requested service in response to receiving the Service Request 130. The determination may be based on, for example, the parameter data 130 contained in the Service Request 125.

After determination of the fee payable for the fee-based service, the ticket computer server 50 may, in step 140a, determine whether one or more specific payment options may be offered to the UE 40 or a user of the UE 40. It may, for example, be determined whether the fee exceeds a pre-determined threshold, e.g., $20.00, in which case only a single option of direct payment will be offered to the UE 40 or the user of the UE 40. That is, if the fee exceeds the pre-determined threshold, then immediate settlement of the fee is demanded by the ticket computer server 50 from the UE 40 or the user of the UE 40.

If the fee does not exceed the pre-determined threshold, the ticket computer server 50, then two or more payment options may be determined in step 140a and offered to the UE 40 or the user of the UE 40. In such instance, for example, the UE 40 or the user of the UE 40 may be offered an option for direct payment and another option for deferred payment. The determining step 135 may also take into account the total balance of a user or specific account associated with the identification data of the UE 40, and determine valid payment options from whether the account exceeds a limit or not. Although step 140a is depicted as being performed by the of determining the payment options may be performed by the ticket computer server 50, it may alternatively be performed subsequently by the UE 40 as step 140b, and is therefore such alternative steps are indicated in FIG. 2 with dashed line boxes.

The ticket computer server 50 then, in step 142, transmits to the UE 40 a Service Offer message 145 comprising at least the data 150 of, for example, fee information that relates to the requested and now offered fee-based service. Other information may also be transmitted in data 150 along with the Service Offer 145 including, e.g., descriptive information of the service offered and the determined information relating to payment options to be presented to a user of the UE 40. If the payment options are determined in step 140a, then the parameter 150 may also include information relating to payment options. The information relating to payment options may comprise, for example, an indication whether in addition to an immediate payment option, a deferred payment option may be offered to the UE 40 or user of the UE 40.

As indicated above, if the Service Offer 145e does not comprise any payment option information, the UE 40 may determine the payment options in alternative step 140b for presentation to the user according to pre-defined rules and/or filters. Such rules or filters may, for example, be preconfigured by a service provider or well-known and they may allow the UE 40 to apply a similar logic as the rules described for the optional determination of payment options in step 140a by the ticket computer server 50.

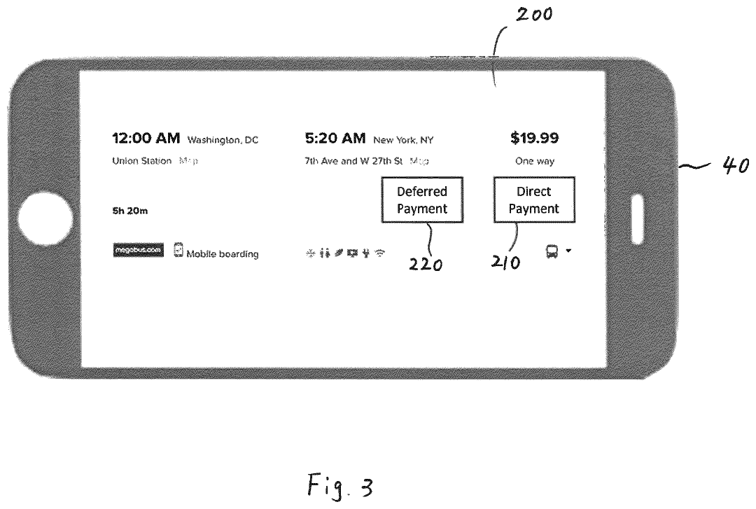

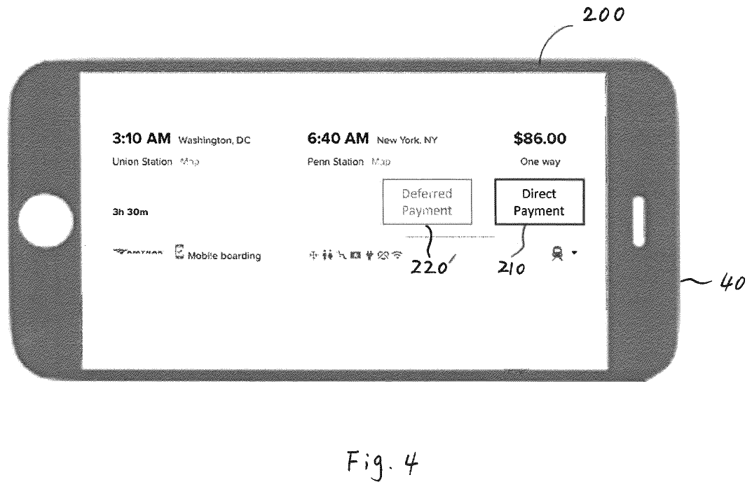

The UE 40 may then, in step 155, display information about the fee-based service, e.g. the fee received from the ticket computer server 50, and offer the payment options received or determined. FIG. 3 depicts an example of the display 200 of the UE 40 displaying information of an offered service along with two payment options, e.g., a direct payment option 210, and a deferred payment option 220. In the case only one option is to be offered to the user or the ticket amount exceeds a predetermined threshold amount, the user may be presented with an image showing for example, one payment option, or the two payment options, but with one option being deactivated, e.g., greyed out, or otherwise presented as deactivated or unselectable as is depicted in FIG. 4. In FIG. 4, the deferred payment option is in a deactivated or unselectable state as presented by reference number 220′, which may have been caused by the ticket computer server 50 based on the requested ticket cost exceeding a predetermined threshold amount of, for example, $20.00.

Referring again to FIG. 2, in connection with the displaying information step 155, the UE 40 may accept an input selection from a user in step 160 for acceptance of the fee presented on the display via a selected payment option. As an indication of the acceptance of the fee by the user, the UE 40 in step 165 transmits a Service Accept message 170 to the ticket computer server 50. Such Service Accept message 170 may comprise, for example, data 175 indicative of the selected payment option.

In step 180, the ticket computer server 50 then processes the received information 175 to identify the selected payment option. If the deferred payment option has been selected, the process 100 then proceeds to step 185. In step 185, the ticket computer server 50 transmits to the deferred payment server 60 a Deferred Payment Request message 187. The Deferred Payment Request 187 may comprise data 188 of at least a unique identifier of the UE 40 requesting the deferred payment of the fcc-based service. The data 188 in the Deferred

Payment Request 40 may further comprise information about the fee to be paid by the UE 40 or the user of the UE 40.

The deferred payment server 60 then, in step 190, processes the request for deferred payment by, for example, the methods and structured described in, for example, U.S. Patent Publication No. 2012/0166339 A1 to C. Ene, published Jun. 28, 2012 and entitled “Payment System, Purchasing System, and Method for Performing a Plurality of Payment Processes,” which is hereby incorporated by reference in its entirety herein. This publication describes a payment system and methods for a plurality of associated payment processes. The system and methods are invoked for a user using a mobile or other internet-accessible computing device, i.e., a “buyer device,” to make a purchase of a good or service from an online shop for a certain purchase amount. The system stores an identification number of the user's buyer device, stores the purchase amount in relation to the identification number, receives a request from the online shop to account for the purchase amount, and sends a request for settlement of at least a part of the total amount of purchases to a user of the buyer device only when the total amount of purchases exceeds a predefined value and/or after the expiry of a predefined time interval.

This publication describes a system and methods that allows a user to make purchases online with her/his buyer system for a purchase amount which the buyer initially does not have to settle. The deferred payment system accumulates the amounts of purchases from the user's buyer device so long as the cumulative amount does not exceed a predefined value. Once the total exceeds the predefined value, the user is requested to settle either the total amount due or at least part of this amount. The buyer device in this case can be implemented on a mobile phone or the like. The purchases and purchase amounts are stored by the payment system in relation to a user system identifier, which preferably does not reveal a personal identifier of the user. It requires no registration or any other user interaction.

Referring again to FIG. 2, upon completing the deferred payment process in step 190, the deferred payment server 60 in step 193, transmits to the ticket computer server 50 a Deferred Payment Complete message 195. The Deferred Payment Complete message 195 may comprise data 196 including, for example, a unique transaction ID of the deferred payment and additionally parameter information about the purchased fee-based service.

In response to receiving the Deferred Payment Complete message 195, the ticket computer server 50 may, in step 197, transmit a Transaction Complete message 198 to the UE 40. Such Transaction Complete message 198 may include, for example, data 199 such as the unique transaction ID and a ticket identifier in the form of, for example, an image of a ticket, an identity of a ticket usable to identify the ticket towards other devices, e.g. a ticket identity code in the form of, for example, a QR code, or a link to or address of a ticket or such ticket identity information so the ticket can be retrieved by the UE 40 at a later point in time.

Accordingly, the process 100 enables a user to initiate and complete a transaction for a time-sensitive or other service using a deferred payment option on their UE in a substantially reduced number of steps relative to traditionally paper and electronic ticket purchase methods.

If in step 180 of the process 100, the ticket computer server 50 determines that the user has selected the immediate payment option, the ticket computer server 50 may process such immediate payment request using conventional techniques such as, for example, processing such request through a payment service provider, e.g., bank, via a credit or debit card transaction, or through the debiting of a virtual wallet associated with the UE 40. An exemplary method for providing a virtual wallet and debiting the purchase price is described in, for example, U.S. Patent Publication No. 2002/0022472 A1 to Watler et al., published on Feb. 21, 2002 and entitled “Multiple Virtual Wallets in Wireless Device,” which is hereby incorporated by reference in its entirety herein.

It will be understood that, while various aspects of the present disclosure have been illustrated and described by way of example, the invention claimed herein is not limited thereto, but may be otherwise variously embodied within the scope of the following claims. For example, it should be understood that while the ticket computer server 50 determined the payment method in step 180 of FIG. 2, such server may rely on instructions from a third party payment service provider, such as the operators of the deferred payment server 60, to only offer to the UE 40, the immediate payment option for the requested transaction. Further, the ticket computer server 50 and deferred payment server 60 have been described with regard to FIG. 2 as separate servers for ease of understanding only, it is further contemplated that the operations of these servers may be performed by a single server, or a greater number of servers.

In addition, the ticket computer server 50 may impose a time limit period for which the indicated fee to the user for use of the offered fee-based service is valid. If such time limit period has expired, the UE may inhibit the transmission of selected payment option by the user. Also, such time period may be initiated based on the time the image of the service code signage is captured in, for example, step 110 of FIG. 2.

We claim:

1. A mobile device computer-implemented method for initiating a purchase transaction for services based on signage, the method comprising the steps of:
capturing by an image sensor of a mobile device, an image of service code signage depicting a code associated with an offered fee-based service;
processing [by the mobile device,] the captured image of the service code signage to identify an address of a first network-accessible computer server associated with the offered fee-based service and at least one parameter associated with the offered fee-based service;
transmitting to the address of the first computer server, information of the at least one parameter associated with the offered fee-based service, and a network-accessible address associated with the mobile device;
receiving from the first computer server, information associated with the offered fee-based service including at least a fee for use of the fee-based service;
displaying on the mobile device, the received information and at least two payment options including an immediate payment option and a deferred payment option;
receiving from a user of the mobile device, a selected payment option for use of the fee-based service;
transmitting to the address of the first computer server, information indicative of the selected payment option for the offered fee-based service;
transmitting a unique identifier to an address of network-accessible second computer server when said deferred payment option is selected, wherein the second computer server is associated with a deferred payment service provider; and
receiving information of a completed transaction for the offered fee-based service including at least a unique transaction identifier and a parameter associated with at least one aspect of the fee-based service to be used.

2. The mobile device computer-implemented method of claim 1 wherein the displaying step is performed when the fee is below a pre-determined threshold amount; and further comprising the step of displaying on the mobile device, the received information and at least one payment for immediate payment when the fee is above the pre-determined threshold amount.

3. The mobile device computer-implemented method of claim 1 or 2 further comprising the step of displaying on the mobile device, the at least one immediate payment option, wherein the at least one immediate payment immediate payment option includes immediate payment by a third party payment service provider.

4. The mobile device computer-implemented method of claim 1 wherein the first and second computer servers are the same computer server.

5. The mobile device computer-implemented method of claim 1 wherein the information associated with the offered fee-based service received in the receiving step for such information associated with the offered fee-based service, further includes a time period for which the fee for use of the offered fee-based service is valid.

6. The mobile device computer-implemented method of claim 5 further comprising the step of inhibiting performance of the transmitting step of the information indicative of the selected payment option for the offered fee-based service if the time period has expired when the selected payment option has been received by the user.

7. The mobile device computer-implemented method of claim 5 wherein a start of the time period for which said offered fee-based service is based on the time of performance of the image capturing step.
